(19) United States
(12) Patent Application Publication
(10) Pub. No.: US 2025/0101668 A1
(43) Pub. Date: Mar. 27, 2025

(54) LAUNDRY TREATING APPARATUS

(71) Applicant: LG Electronics Inc., Seoul (KR)

(72) Inventors: Bohyun NAM, Seoul (KR); Hoil Jeon, Seoul (KR); Junseop Lee, Seoul (KR); Jaeil Bae, Seoul (KR)

(73) Assignee: LG Electronics Inc., Seoul (KR)

(21) Appl. No.: 18/895,819

(22) Filed: Sep. 25, 2024

(30) Foreign Application Priority Data
Sep. 26, 2023 (KR) 10-2023-0129650

(51) Int. Cl. D06F 39/14; D06F 25/00; E05D 3/02

(52) U.S. Cl. CPC D06F 39/14; D06F 25/00; E05D 3/02; E05Y 2900/312

(57) ABSTRACT

Disclosed is a laundry treating apparatus including a cabinet, an accommodation portion to accommodate laundry therein, a door seating portion, and a door, wherein the door includes a door frame pivotably coupled to a front panel and accommodated in the door seating portion, and a door cover covering a front surface of the door frame and exposed forward, wherein the door frame is accommodated in the door seating portion so as not to protrude forward of the front panel.

This application claims the benefit of Korean Patent Application No. 10-2023-0129650,filed on Sep. 26, 2023, which is hereby incorporated by reference as if fully set forth herein.

### BACKGROUND

### Field

The present disclosure relates to a laundry treating apparatus, and more particularly, to a laundry treating apparatus including a door that opens and closes an inlet through which laundry is introduced.

### Discussion of the Related Art

A laundry treating apparatus is an apparatus that may perform various treatment courses for treating laundry, such as a washing course of putting clothes, bedding, and the like (hereinafter, referred to as the laundry) into a drum and removing contaminants on the laundry or a drying course for removing moisture from the laundry.

The laundry treating apparatus may include a cabinet forming an outer appearance thereof, and may include an accommodation portion disposed inside the cabinet to receive the laundry therein. In addition, when water is used in the treatment course of the laundry, a tub may be disposed inside the cabinet and the accommodating portion may be installed inside the tub.

In one example, an inlet may be defined in the cabinet, and the inlet may be in communication with the interior of the accommodation portion. A user may put the laundry into the accommodation portion via the inlet.

The laundry treating apparatus may include a door for opening and closing the inlet. The door may be disposed on the cabinet and may be in an opening state of opening the inlet or in a closing state of closing the inlet.

The door may be coupled to the cabinet via a hinge. The door may pivot about the hinge to correspond to the opening state or the closing state.

Related document KR 10-2015-0053145 A1 discloses a laundry treating apparatus having the door disposed on a front surface of the cabinet. In the laundry treating apparatus of the related document, the door pivots to be in close contact with the cabinet to close the inlet, and pivots to be away from the cabinet to open the inlet.

In addition, in the laundry treating apparatus of the related document, the cabinet may include a door seating portion such that the door in the state of closing the inlet may be seated, and the door may be seated on the door seating portion to seal the door.

However, the door of the related document has an area size greater than that of the door seating portion and is constructed to cover the door seating portion from the front. In this case, an amount the door protrudes forward from the front surface where the door seating portion is defined increases, so that the door occupies a space in front of the cabinet.

As the door protrudes forward of the cabinet, the user should use the laundry treating apparatus while being forwardly away from the cabinet, which may increase inconvenience and may interfere with placement of other objects in front of the laundry treating apparatus.

Therefore, reducing the forward protrusion amount of the door has become an important issue in terms of convenience of use and space utilization of the laundry treating apparatus, and furthermore, improving visual completeness to the user of the front surface that faces the user in the cabinet and includes the door has become an important issue.

In one example, a separation distance, i.e., a gap, may be defined between an edge of the door seating portion and an edge of the door for smooth pivoting of the door. As a period of use of the door increases, the door may sag because of an own weight thereof, and as a result, a lower end of the door may come into contact with the door seating portion, which may interfere with the pivoting of the door.

In addition, the gap generally has a uniform width for an entirety of a perimeter of the door, but the gap on one side of the door that is connected to the hinge needs to have a width that may secure a pivoting range centered on the hinge.

However, when the width of the entirety of the perimeter of the door is increased uniformly by the increase in the width of the gap considering the hinge on the one side of the door, an area size of the door seating portion may increase unnecessarily, which may lower a level of completion of a product in terms of the outer appearance of the laundry treating apparatus.

Therefore, efficiently designing the gap defined around the door and developing the laundry treating apparatus that includes the door seating portion that may effectively accommodate the door have become important issues in the present technical field.

### SUMMARY

Embodiments of the present disclosure are to provide a laundry treating apparatus having a door seating portion that accommodates at least a portion of a door therein.

In addition, embodiments of the present disclosure are to provide a laundry treating apparatus in which a gap between a door seating portion and a door may be efficiently defined in consideration of usability of the door.

In addition, embodiments of the present disclosure are to provide a laundry treating apparatus that may effectively maintain usability of a door even when the door sags because of an own weight thereof.

In addition, embodiments of the present disclosure are to provide a laundry treating apparatus including a door seating portion that allows a door to pivot smoothly and suppresses an unnecessary area size increase thereof.

In addition, embodiments of the present disclosure are to provide a laundry treating apparatus that may effectively reduce a protrusion amount of a door protruding forward from a front panel.

In addition, embodiments of the present disclosure are to provide a laundry treating apparatus that may provide a user with an outer appearance in which a front panel and a door are visually flattened.

In an embodiment of the present disclosure, a front panel may include a door seating portion that opens and closes an inlet. A door may be accommodated in the door seating portion in a state of closing the inlet.

In an embodiment of the present disclosure, the door may be accommodated in the door seating portion so as not to protrude forward of a front panel. A front end of a door frame may be positioned on the same plane as a front end of the front panel.

The door may include a door cover disposed on a front surface of the door frame, and the door cover may protrude forward of the front surface of the front panel. Accordingly, an entirety of the front panel may provide a visual flat image.

Such laundry treating apparatus according to an embodiment of the present disclosure includes a cabinet including a front panel having an inlet defined therein, an accommodation portion disposed inside the cabinet to accommodate laundry input via the inlet therein, a door seating portion defined in the front panel, surrounding the inlet, and recessed rearward, and a door pivotably disposed on the front panel to open and close the inlet, wherein at least a portion of the door is accommodated in the door seating portion in a state of closing the inlet.

The door includes a door frame pivotably coupled to the front panel and accommodated in the door seating portion, and a door cover covering a front surface of the door frame and exposed forward.

The door frame is accommodated in the door seating portion so as not to protrude forward of the front panel. The door frame may include a through-hole defined therein to face the inlet, and the through-hole may be closed from the front by the door cover.

The door cover may have a light-transmitting property such that the through-hole may be visually identified from a space in front of the door. A front end of the door frame may be positioned on the same plane as a front surface of the front panel.

An edge of the door frame may include a frame circumferential portion protruding forward and extending along an edge of the door cover, and the door may be accommodated in the door seating portion such that a front end of the frame circumferential portion does not protrude forward of the front panel.

The front end of the frame circumferential portion may be positioned on the same plane as a front surface of the front panel. The door frame may include an outer frame having the door cover disposed on a front surface thereof, and an inner frame coupled to the outer frame from the rear and facing the inlet, and the outer frame may be accommodated in the door seating portion so as not to protrude forward of the front panel.

A frame circumferential portion protruding forward and extending along an edge of the door cover may be disposed at an edge of the outer frame, and the frame circumferential portion may be accommodated in the door seating portion so as not to protrude forward of the front panel.

An edge of a front surface of the door cover may be positioned forward of a front surface of the front panel. A portion of the door cover may be accommodated in the door seating portion and positioned rearward of the front surface of the front panel.

The door cover may have a color with a lower brightness than a color of the front panel. The front surface of the door cover may be a plane perpendicular to the ground and may be positioned forward of the front surface of the front panel.

The front surface of the door frame may be positioned rearward of a front surface of the front panel, and an edge of a front surface of the door cover may be positioned forward of the front surface of the front panel.

A cover seating portion recessed rearward may be defined in the front surface of the door frame, and a portion of the door cover may be accommodated in the cover seating portion and a remainder thereof may protrude forward of the door frame.

An edge of the door frame may include a frame circumferential portion protruding forward and extending along a circumferential surface of the door cover, and an edge of a front surface of the door cover may protrude forward of the frame circumferential portion.

The door cover may include a connecting curved surface connecting an edge of a front surface of the door cover with a front end of a circumferential surface of the door cover, and at least a portion of the connecting curved surface may protrude forward of the front panel.

At least a portion of the circumferential surface of the door cover may be positioned rearward of a front surface of the front panel.

An embodiment of the present disclosure may further include a door lock disposed on the cabinet to restrain forward pivoting of the door in the closing state accommodated in the door seating portion.

When a door button disposed on a front surface of the door is manipulated, the door lock may releases the restraint of the door and push the door forward.

When the door whose forward pivoting is restrained is pressed toward the cabinet, the door lock may release the restraint of the door and push the door forward.

The embodiments of the present disclosure may provide the laundry treating apparatus having the door seating portion that accommodates at least the portion of the door therein.

In addition, the embodiments of the present disclosure may provide the laundry treating apparatus in which the gap between the door seating portion and the door may be efficiently defined in consideration of the usability of the door.

In addition, the embodiments of the present disclosure may provide the laundry treating apparatus that may effectively maintain the usability of the door even when the door sags because of the own weight thereof.

In addition, the embodiments of the present disclosure may provide the laundry treating apparatus including the door seating portion that allows the door to pivot smoothly and suppresses the unnecessary area size increase thereof.

In addition, the embodiments of the present disclosure may provide the laundry treating apparatus that may effectively reduce the protrusion amount of the door protruding forward from the front panel.

In addition, the embodiments of the present disclosure may provide the laundry treating apparatus that may provide the user with the outer appearance in which the front panel and the door are visually flattened.

### BRIEF DESCRIPTION OF THE DRAWINGS

FIG. 1 is a perspective view showing a laundry treating apparatus according to an embodiment of the present disclosure.

FIG. 2 is a perspective view showing a laundry treating apparatus according to an embodiment of the present disclosure stacked on an additional treating apparatus.

FIG. 3 is a front view of a laundry treating apparatus according to an embodiment of the present disclosure.

FIG. 4 is a side view of a laundry treating apparatus according to an embodiment of the present disclosure.

FIG. 5 is a cross-sectional view showing interior of a laundry treating apparatus according to an embodiment of the present disclosure.

FIG. 6 shows a control panel of a laundry treating apparatus according to an embodiment of the present disclosure.

FIG. 7 shows a door of a laundry treating apparatus according to an embodiment of the present disclosure.

FIG. 8 shows a door in FIG. 7 pivoted to be in an opening state.

FIG. 9 shows a gap defined between an edge of a door seating portion and an edge of a door in an embodiment of the present disclosure.

FIG. 10 shows an upper end gap defined at an upper end of a door and a lower end gap defined at a lower end of the door in an embodiment of the present disclosure.

FIG. 11 shows a gap at one end located at one end of a door and a gap at an opposite end located at an opposite end of the door in an embodiment of the present disclosure.

FIG. 12 shows a center of a door seating portion and a center of a door in an embodiment of the present disclosure.

FIG. 13 is a lateral cross-sectional view of a door in an embodiment of the present disclosure.

FIG. 14 shows a door protruding forward of a front panel in an embodiment of the present disclosure.

FIG. 15 shows a front end of a door frame and a door cover in an embodiment of the present disclosure.

FIG. 16 shows a door not protruding forward of a front panel in an embodiment of the present disclosure.

FIG. 17 shows a door button and a pressing portion disposed on a door in an embodiment of the present disclosure.

FIG. 18 shows a door pivoted by a door button or a pressing portion in an embodiment of the present disclosure.

FIG. 19 shows a door lock that fixes a door in an embodiment of the present disclosure.

### DESCRIPTION OF SPECIFIC EMBODIMENTS

Hereinafter, with reference to the attached drawings, embodiments of the present disclosure will be described in detail such that those skilled in the art may easily practice them.

However, the present disclosure may be implemented in several different forms and may not be limited to the embodiments described herein. Further, to clearly illustrate the present disclosure in the drawings, parts unrelated to the description are omitted, and similar drawing numerals are assigned to similar parts throughout the present document.

In the present document, redundant descriptions of the same components are omitted.

Further, in the present document, when a component is referred to as being ‘connected’ to another component, it should be understood that the components may be directly connected to each other, but there may be another component therebetween. On the other hand, in the present document, when a component is referred to as being ‘directly connected’ to another component, it should be understood that there is no other component therebetween.

Additionally, the terms used herein are merely used to describe specific embodiments and are not intended to limit the present disclosure.

Further, as used herein, singular expressions may include plural expressions, unless the context clearly dictates otherwise.

In addition, in the present document, it should be understood that terms such as ‘include’ or ‘have’ are only intended to indicate the presence of features, numbers, steps, operations, components, parts, or combinations thereof described herein, and do not preclude the presence or addition of other features, numbers, steps, operations, components, parts, or combinations thereof.

Further, in the present document, the term ‘and/or’ includes a combination of a plurality of listed items or any of the plurality of listed items. As used herein, ‘A or B’ may include ‘A’, ‘B’, or ‘both A and B’.

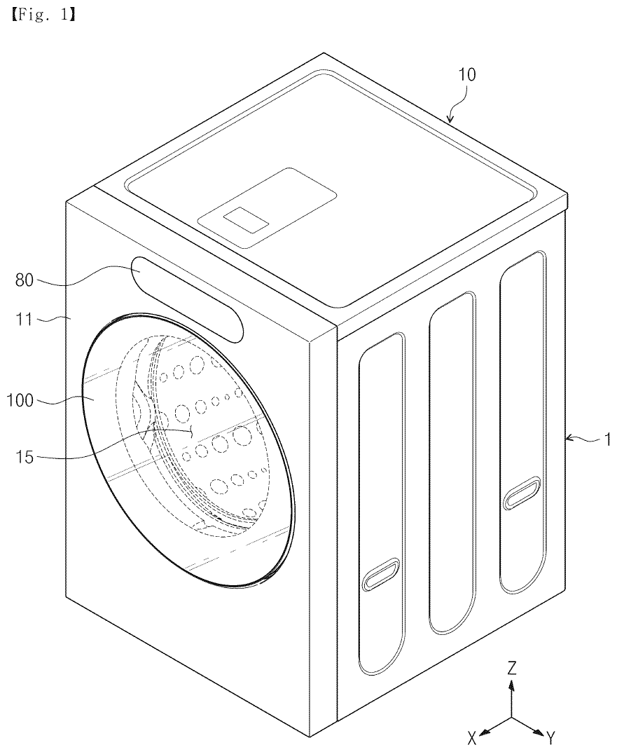

FIG. 1 shows a front perspective view of a laundry treating apparatus 1 according to an embodiment of the present disclosure.

In an embodiment of the present disclosure, the laundry treating apparatus 1 is constructed to treat laundry. The treatment of the laundry may be of various types, such as washing and drying. The laundry treating apparatus 1 includes a cabinet 10.

The cabinet 10 may form an outer appearance of the laundry treating apparatus 1 and may have therein a space in which various components may be disposed. The cabinet 10 may have an approximately hexahedral shape and may include panels defining respective surfaces.

For example, the cabinet 10 may include a front panel 11, a side panel, a top panel, a rear panel, and the like. The plurality of panels may be coupled to each other to form the cabinet 10.

An inlet 15 may be defined in the cabinet 10. The inlet 15 may allow the outside and the inside of the cabinet 10 to be in communication with each other. A user may put the laundry into the cabinet 10 via the inlet 15.

The inlet 15 may be defined at various locations in the cabinet 10. For example, the inlet 15 may be defined in the front panel 11 of the cabinet 10. The user may be positioned in front of the cabinet 10 and put the laundry into the cabinet 10 via the inlet 15.

An accommodation portion 20 may be disposed inside the cabinet 10. The accommodation portion 20 may be disposed inside the cabinet 10 and may accommodate therein the laundry input via the inlet 15. A detailed description of the accommodation portion 20 will be made later.

An embodiment of the present disclosure may include a control panel 80. The control panel 80 may be exposed externally to the cabinet 10. The user may use the laundry treating apparatus 1 by manipulating the control panel 80 or based on information provided by the control panel 80. A detailed description of the control panel 80 will be made later.

An embodiment of the present disclosure may include a door 100. The door 100 may be disposed on the front panel 11 to open and close the inlet 15. In addition, the door 100 may be disposed on the front panel 11 to open and close the inlet 15, and may at least partially accommodated in a door seating portion 200 in a state DC of closing the inlet 15. A detailed description of the door 100 will be made later.

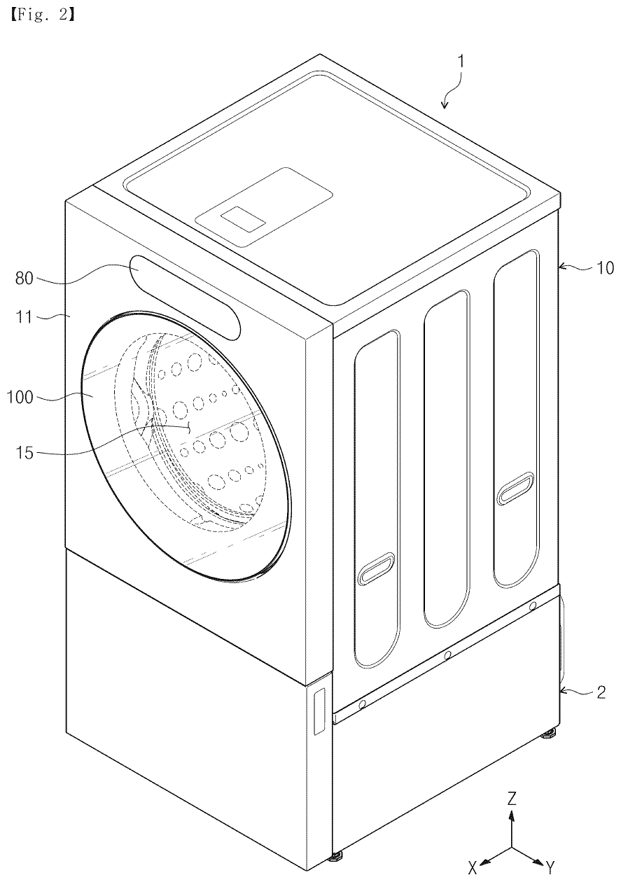

FIG. 2 shows the laundry treating apparatus 1 disposed on an additional treating apparatus 2 according to an embodiment of the present disclosure. The laundry treating apparatus 1 according to an embodiment of the present disclosure may be disposed together with an external apparatus such as the additional treating apparatus 2 to perform an associated treatment process of the laundry.

For example, the additional treating apparatus 2 may perform the treatment of the laundry independently of the laundry treating apparatus 1 according to an embodiment of the present disclosure. That is, the additional treating apparatus 2 may support the laundry treating apparatus 1 upwardly and accommodate and treat the laundry inside.

The laundry treating apparatus 1 according to an embodiment of the present disclosure may be designed to be used together with the additional treating apparatus 2. For example, a top surface of the additional treating apparatus 2 may have a shape for supporting the laundry treating apparatus 1.

The additional treating apparatus 2 may be constructed to be opened via a front surface thereof such that the user positioned in front of the laundry treating apparatus 1 may easily use the additional treating apparatus 2.

The front surface of the additional treating apparatus 2 and the front surface of the laundry treating apparatus 1 may constitute a front surface of one product together. For example, the front surface of the additional treating apparatus 2 and the front surface of the laundry treating apparatus 1 may be positioned on the same plane.

The above-described control panel 80 may provide information on not only the laundry treating apparatus 1 but also the additional treating apparatus 2 or to receive a user's command signal.

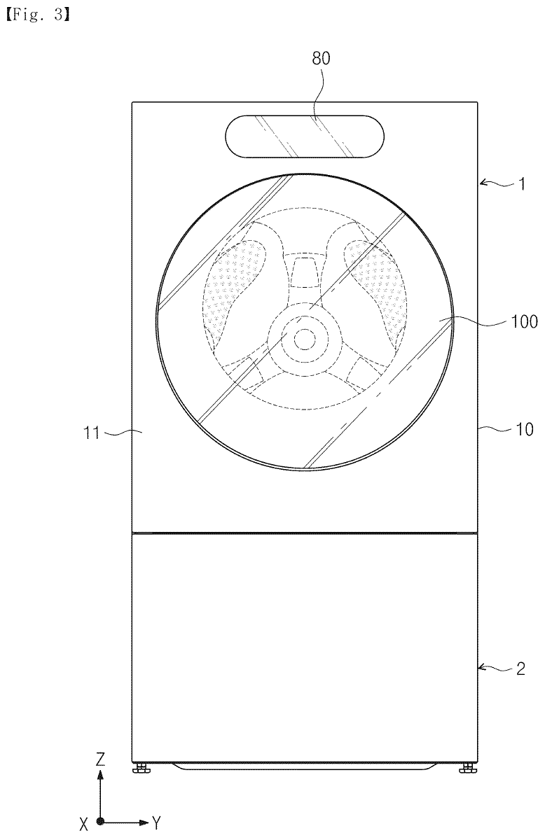

FIG. 3 shows the front surface of the laundry treating apparatus 1 according to an embodiment of the present disclosure. FIG. 3 shows the front surfaces of the laundry treating apparatus 1 and the additional treating apparatus 2 together.

The control panel 80 and the door 100 described above may be disposed on the front panel 11 of the cabinet 10. The front panel 11 may include the inlet 15 that is opened and closed by the door 100 and a control panel hole 15 for the control panel 80 to be installed to be exposed to the outside.

The front panel 11 of the cabinet 10 may be formed such that no other opening 15 exists other than the inlet 15 and the control panel hole 15 when viewed from the front. Accordingly, an embodiment of the present disclosure may provide a simple outer appearance to the user and may improve recognition convenience of the user for each component of the product.

In addition, as described above, the front surfaces of the laundry treating apparatus 1 and the additional treating apparatus 2 may constitute a single plane together. Accordingly, the user may recognize the two treating apparatuses as a single integrated apparatus in terms of the outer appearance.

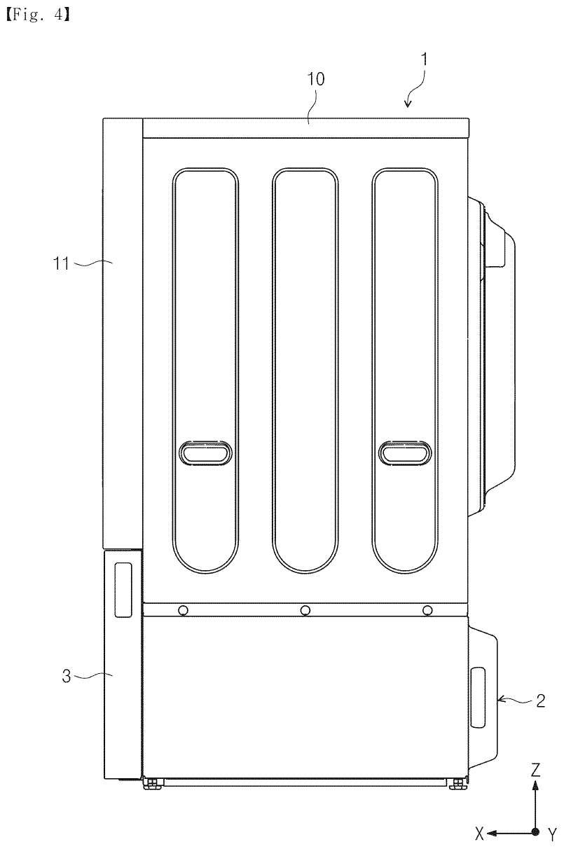

FIG. 4 shows a side surface of the laundry treating apparatus 1 according to an embodiment of the present disclosure. FIG. 4 shows side surfaces of the laundry treating apparatus 1 and the additional treating apparatus 2 described above together.

A height of the laundry treating apparatus 1 may be greater than that of the additional treating apparatus 2. In this case, the laundry treating apparatus 1 may be advantageous in treating a relatively large amount of laundry, and the additional treating apparatus 2 may be advantageous in quickly treating a relatively small amount of laundry.

The additional treating apparatus 2 may include a drawer 3 that extends forward, and the drawer 3 may include an additional accommodation portion 4 for accommodating the laundry therein. A front surface of the drawer 3 may correspond to the front surface of the additional treating apparatus 2.

The front surface of the additional treating apparatus 2 may protrude upward from the additional treating apparatus 2 and be positioned at a lower portion of the laundry treating apparatus 1. In this case, an upper end of the front surface of the additional treating apparatus 2 may be positioned in front of the side surface of the laundry treating apparatus 1.

That is, the front surface of the laundry treating apparatus 1 may be defined by the front panel 11 described above and a portion of the front surface of the additional treating apparatus 2.

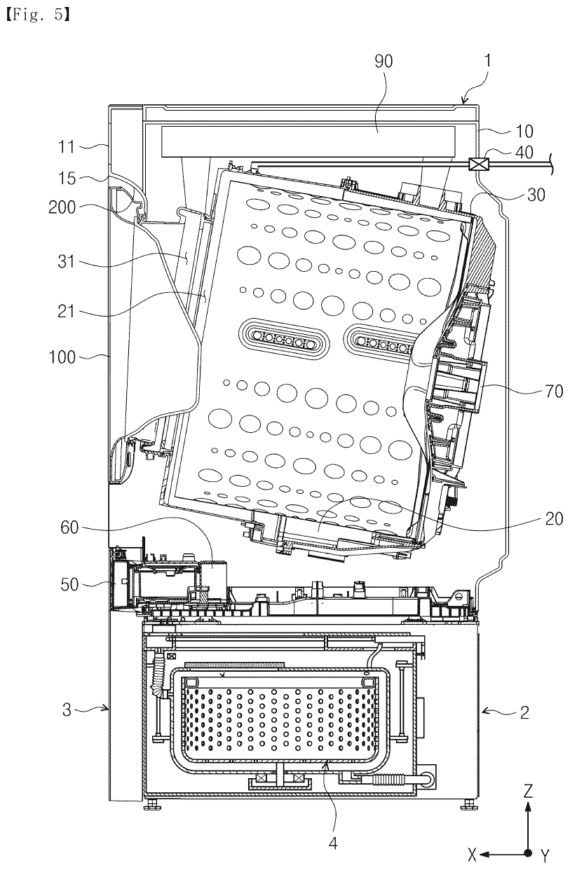

FIG. 5 shows the interior of the laundry treating apparatus 1 according to an embodiment of the present disclosure. FIG. 5 also shows the interior of the additional treating apparatus 2 together with that of the laundry treating apparatus 1.

An embodiment of the present disclosure may perform the various treatments such as the washing and the drying of the laundry as described above. Hereinafter, as an example, a description will be made based on a structure in which the laundry treating apparatus 1 according to an embodiment of the present disclosure is able to perform both the washing and the drying of the laundry.

An embodiment of the present disclosure may include a tub 30. The tub 30 may be disposed inside the cabinet 10 and may store water therein.

The accommodation portion 20 may be constructed to be rotatable inside the tub 30 and may accommodate the laundry therein.

Each of the tub 30 and the accommodation portion 20 may have a cylindrical shape. The tub 30 may include an inlet 31 of the tub 30 facing forward, and the accommodation portion 20 may include an accommodation portion inlet 21 facing forward.

Each of the inlet 31 of the tub 30 and the accommodation portion inlet 21 may face the inlet 15 of the cabinet 10 described above. Accordingly, the laundry input via the inlet 15 of the cabinet 10 may pass through the inlet 31 of the tub 30 and the accommodation portion inlet 21 and be accommodated inside the accommodation portion 20.

The accommodation portion 20 may be referred to as a drum, and may include a plurality of holes defined in a circumferential surface thereof such that water stored in the tub 30 may be introduced thereinto. The accommodation portion inlet 21 described above may be defined in a front surface of the accommodation portion 20, and a rear surface of the accommodation portion 20 may be directly or indirectly coupled with a rotation shaft for the rotation.

An embodiment of the present disclosure may include a driver 70, and the driver 70 may be coupled to a rear surface of the tub 30 or the cabinet 10. The driver 70 may provide a rotational force to the drum via the rotation shaft.

An embodiment of the present disclosure may include a water supply 40. The water supply 40 may be connected to a water supply source outside the cabinet 10 to receive water, and may supply water into the tub 30. The water supply 40 may include a water supply pipe for a flow of water, a water supply valve for regulating the flow of water, and the like.

An embodiment of the present disclosure may include a drainage 60. The drainage 60 may be disposed below the tub 30 and may discharge water from the tub 30. The drainage 60 may include a drain pipe that allows the tub 30 and the outside of the cabinet 10 to be in communication with each other and a drain pump for forming the flow of water.

An embodiment of the present disclosure may include a detergent unit 50. The detergent unit 50 may supply detergent into the tub 30. The detergent unit 50 may store the detergent therein, and the detergent unit 50 may be connected to the water supply 40 or the drainage 60 to supply the detergent into the tub 30.

For example, the detergent unit 50 may be connected to the drainage 60, the drainage 60 may include a circulating flow channel through which water inside the tub 30 circulates and a circulating pump, and the detergent unit 50 may supply the detergent into the circulating flow channel to provide the detergent into the tub 30.

An embodiment of the present disclosure may include an air supply 90. The air supply 90 may supply high-temperature, dry air into the tub 30 to perform the drying process of the laundry. The air supply 90 may be disposed at various locations. For example, the air supply 90 may be disposed above the tub 30 and fixed to the tub 30 or the cabinet 10.

The air supply 90 may receive air inside the tub 30, treat air to have a high temperature and be dried, and then supply air back into the tub 30. That is, an embodiment of the present disclosure may be of a circulation drying type in which the drying process of the laundry is performed as air in the tub 30 circulates.

In one example, as described above, the additional treating apparatus 2 may be disposed beneath the laundry treating apparatus 1. The additional treating apparatus 2 may include an additional cabinet that forms an outer appearance thereof and supports the cabinet 10 of the laundry treating apparatus 1.

The additional accommodation portion 4 for accommodating the laundry therein may be disposed inside the additional cabinet, and the additional accommodation portion 4 may be included in the drawer 3 described above and may be extended forward from the additional cabinet.

A front surface of the additional cabinet may be opened, and the drawer 3 may be extended forward via the open front surface of the additional cabinet. The drawer 3 may include a front surface forming the front surface of the additional treating apparatus 2, and the front surface of the drawer 3 may form the same plane together with the front panel 11 of the laundry treating apparatus 1 as described above.

In addition, the additional treating apparatus 2 may include at least one of an additional tub 30, an additional driver, an additional water supply, an additional drainage, an additional detergent unit, and an additional air supply, similar to the laundry treating apparatus 1, when necessary for treating the laundry.

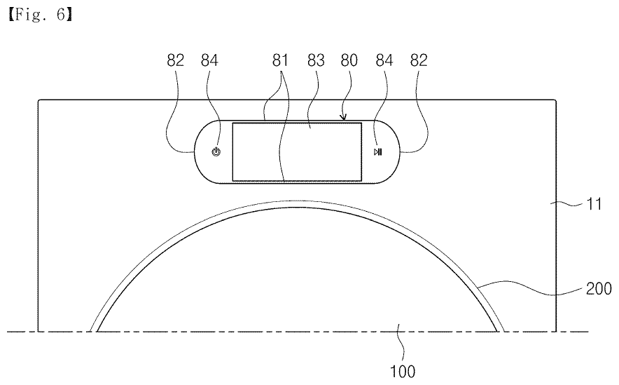

FIG. 6 shows the control panel 80 of the laundry treating apparatus 1 according to an embodiment of the present disclosure.

The control panel 80 may be disposed in the front panel 11, and may be disposed between the door 100 and an upper end of the front panel 11 and manipulated by the user.

The control panel 80 may include an output area 83 on which a screen is output. A display that outputs the screen may be disposed on an inner side of the output area 83, and the output area 83 may be transparent and may overlap the display. A touch film or the like may be disposed on the output area 83 so as to sense a user's touch to the screen.

The user may receive information on the laundry treating apparatus 1 via the screen, and may check a response of the laundry treating apparatus 1 based on the command signal input by the user.

The control panel 80 may be equipped with a manipulation button 84 manipulated by the user. The user may command the laundry treating apparatus 1 by manipulating the manipulation button 84 or touching the output area 83.

The manipulation button 84 may be of various types, such as a mechanical button with a changeable physical protrusion amount or a touch button that senses a user's touch via a touch film or the like.

The manipulation button 84 may include a plurality of manipulation buttons, and may include at least one of a power button that determines whether to turn on the laundry treating apparatus 1 and an execution button for commanding the laundry treating apparatus 1 to perform the laundry treatment process.

In one example, the control panel 80 may include straight edges 81 extending parallel to a width direction of the cabinet 10 at upper and lower sides, respectively, and curved edges 82 disposed at both sides in the width direction and connected to the straight edges 81, respectively.

The edge of the control panel 80 may also be defined as a boundary line with respect to the front panel 11. The edge of the control panel 80 may correspond to an edge of the control panel hole 15 of the front panel 11 described above.

The edges of the control panel 80 may include the straight edges 81 and the curved edges 82. The straight edges 81 may be disposed at the upper and lower sides of the control panel 80, and the curved edges 82 may be disposed at both sides of the control panel 80 based on the width direction of the cabinet 10, respectively.

The straight edge 81 may be parallel to the width direction of the cabinet 10. The curved edge 82 may have an arc shape. Both ends of the curved edge 82 may be connected to the different straight edges 81.

Accordingly, the pair of straight edges 81 may be connected to each other by the curved edges 82, and the pair of straight edges 81 and the pair of curved edges 82 may together define one closed cross-section and may define the edges of the control panel 80.

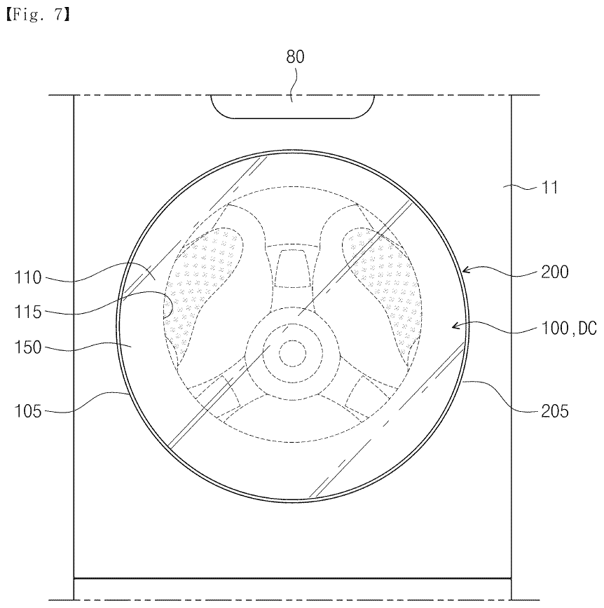

FIG. 7 shows the door 100 of the laundry treating apparatus 1 according to an embodiment of the present disclosure.

The door 100 may be positioned downward of the control panel 80. The door 100 may include a door frame 110 and a door cover 150.

The door frame 110 may be pivotably coupled to the front panel 11 via a hinge 180 or the like to be described later. The door frame 110 may include the hinge 180 at one side, and may pivot around the one side.

The door frame 110 may be in close contact with the front panel 11 in the state DC of closing the inlet 15 of the cabinet 10 described above, and may be spaced apart from the front panel 11 in a state DO of opening the inlet 15.

The door cover 150 may be disposed on a front surface of the door frame 110. The door cover 150 may form the front surface of the door 100. The door cover 150 may cover a front surface 122 of the door frame 110 and may be exposed forward of the cabinet 10.

The door frame 110 may include a through-hole 115. The through-hole 115 may extend through the door frame 110 and allow the outside of the cabinet 10 and the inlet 15 of the cabinet 10 to be in communication with each other. In the closing state DC of the door 100, the through-hole 115 may be positioned to face the inlet 15.

The through-hole 115 may be closed from the front by the door cover 150. Accordingly, an object present outside the door 100 may be blocked from entering the through-hole 115.

In addition, the door cover 150 may have a light-transmitting property such that the through-hole 115 is visually identified from a space in front of the door 100. The door cover 150 may be made of a material such as glass or plastic and may have at least a portion of an area overlapping the through-hole 115 formed to be transparent, so that the user may visually identify the through-hole 115 covered by the door cover 150 and the inlet 15 of the cabinet 10 and may visually check the laundry accommodated in the accommodation portion 20 via the through-hole 115 and the inlet 15.

In one example, the front panel 11 may have the door seating portion 200 where at least a portion of the door 100 is accommodated. The door seating portion 200 may provide a space in which the door 100 closing the inlet 15 is accommodated, thereby reducing a forward protrusion amount of the inlet 15.

In addition, a gap 300 may be defined between an edge 205 of the door seating portion 200 and an edge 105 of the door 100 that are spaced apart from each other. The door 100 accommodated in the door seating portion 200 may pivot smoothly without structural interference with the door seating portion 200 because of the gap 300.

In an embodiment of the present disclosure, at least a portion of the gap 300 may be exposed forward without being covered by the door 100. The gap 300 may be defined throughout the edge 105 of the door 100, and an entirety of the gap 300 may be exposed forward and surround the door 100. A detailed description of the gap 300 will be made later.

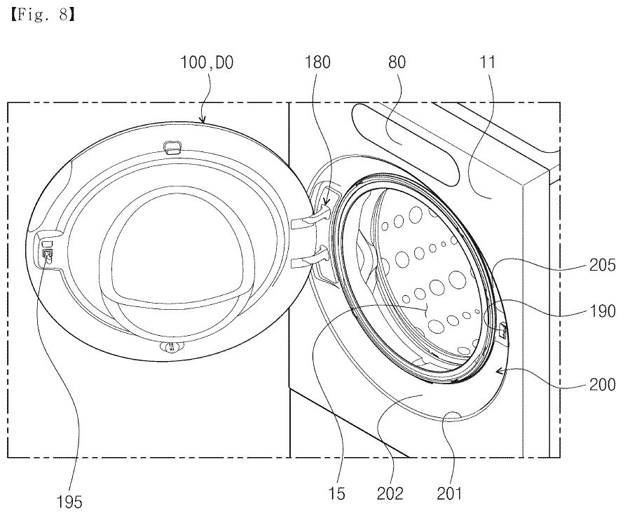

FIG. 8 shows the door seating portion 200 defined in the laundry treating apparatus 1 according to an embodiment of the present disclosure. FIG. 8 shows the door 100 in the opening state DO of opening the inlet 15 of the cabinet 10.

In an embodiment of the present disclosure, the front panel 11 may include the door seating portion 200 that is recessed inward of the cabinet 10 and accommodates at least a portion of the door 100 closing the inlet 15 therein.

The door seating portion 200 may be defined in the front panel 11 where the door 100 and the inlet 15 are disposed. The inlet 15 may be positioned within the door seating portion 200. The door seating portion 200 may surround the inlet 15.

The door seating portion 200 may be formed by recessing a portion of the front panel 11 inward of the cabinet 10, that is, rearward. The door seating portion 200 may be recessed rearward from a front surface 12 defined in the front panel 11 to define the space in which at least the portion of the door 100 is accommodated.

The door seating portion 200 may include a seating circumferential surface 201 and a seating recessed surface 202. The seating circumferential surface 201 may extend rearward from the front surface 12 of the front panel 11, and the seating recessed surface 202 may be offset rearward from the front surface 12 of the front panel 11 and connected to the seating circumferential surface 201.

The door 100 may be coupled to the hinge 180 disposed on the door seating portion 200. That is, the hinge 180 may pivotably couple the door 100 to the door seating portion 200. The hinge 180 may be located on the seating recessed surface 202.

The door seating portion 200 may include a door lock 190 for fixing the door 100 that is closing the inlet 15. The door 100 may include a locking protrusion 195 that is separably coupled to the door lock 190.

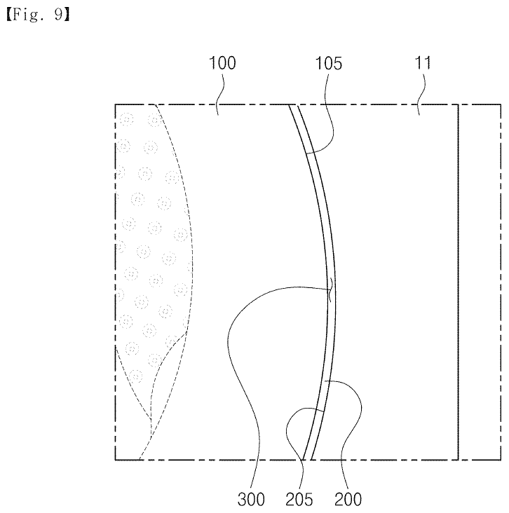

FIG. 9 shows the gap 300 defined between the door seating portion 200 and the door 100 in the laundry treating apparatus 1 according to an embodiment of the present disclosure. Hereinafter, it is preferable to refer to FIG. 7 described above together with FIG. 9 for a description of the gap 300.

As described above, in an embodiment of the present disclosure, the gap 300 may be defined between the edge 205 of the door seating portion 200 and the edge 105 of the door 100. Because of the gap 300, when the door 100 seated on the door seating portion 200 pivots, the interference between the door 100 and the door seating portion 200 is prevented, thereby improving usability of the door 100.

The edge 105 of the door 100 and the edge 205 of the door seating portion 200 may be spaced apart from each other. The gap 300 may be a portion of a space defined inside the door seating portion 200. The gap 300 may extend along the edge 105 of the door 100.

In an embodiment of the present disclosure, the gap 300 between the edge 205 of the door seating portion 200 and the edge 105 of the door 100 may be exposed forward. That is, the edge 105 of the door 100 may be formed so as not to obscure the gap 300 from the front.

The gap 300 may be exposed forward along an entirety of the edge 205 of the door seating portion 200. For example, the door seating portion 200 may have a cross-sectional area greater than that of the door 100, so that the entirety of the gap 300 may surround the door 100.

In other words, a radius of the door seating portion 200 may be greater than that of the door 100. Accordingly, a depth at which the door 100 is accommodated in the door seating portion 200 may be increased, and the amount by which the door 100 protrudes forward may be reduced.

Accordingly, a space required in front of the cabinet 10 may be reduced, a distance between the user and the cabinet 10 may be reduced, and a flat design for the front panel 11 may be provided, thereby improving a level of completion of a product in terms of the outer appearance.

In addition, the edge 205 of the door seating portion 200 and the edge 105 of the door 100 have a circular shape, and the gap 300 may be exposed forward to have a circular shape surrounding the door 100.

When the front panel 11 is viewed from the front, the ring-shaped gap 300 surrounding the circular door 100 may be formed, and accordingly, components having a unified circular design may be disposed, so that the level of completion of the product in terms of the outer appearance may be improved.

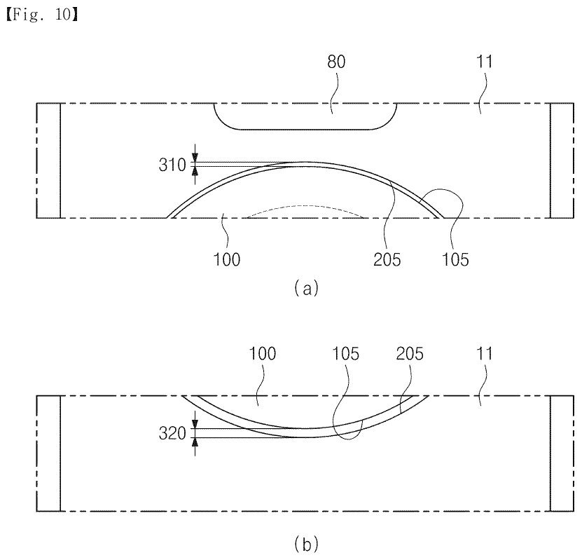

FIG. 10 shows portions of the gap 300 located at different points. (a) in FIG. 10 shows an upper end gap 310 located at an upper end of the door 100, and (b) in FIG. 10 shows a lower end gap 320 located at a lower end of the door 100.

In an embodiment of the present disclosure, the gap 300 defined along the edge 105 of the door 100 and exposed forward of the cabinet 10 may have different thicknesses at different points. In this regard, the thickness may refer to a distance between the edge 105 of the door 100 and the edge 205 of the door seating portion 200. In addition, the thickness may refer to a width of the gap 300 based on a radial direction of the door 100.

In an embodiment of the present disclosure, the gap 300 may include a first point having a first thickness and a second point having a second thickness different from the first thickness. That is, the gap 300 may include the points having the different thicknesses.

The gap 300 may be understood as a space secured between the door seating portion 200 and the door 100, and therefore, a thickness required for each point of the gap 300 may be different. For example, a portion of the gap 300 positioned adjacent to one of the components disposed in the door 100 may need to have a greater separation distance from the door seating portion 200 than other portions.

However, when a thickness of the entirety of the gap 300 is determined based on a maximum thickness required for the entirety of the gap 300, an unnecessary increase in the thickness of the entirety of the gap 300 may occur, which may damage the outer appearance of the product and may be disadvantageous in stable seating of the door 100.

Conversely, when the thickness of the entirety of the gap 300 is set based on a point having a minimum thickness in the gap 300, structural interference between the door 100 and the door seating portion 200 may occur in a portion of the door 100, and thus the smooth pivoting of the door 100 may not occur.

Accordingly, an embodiment of the present disclosure enables efficient formation of the gap 300 by determining the thickness of each point of the gap 300 differently along the edge 105 of the door 100.

For example, in an embodiment of the present disclosure, the gap 300 may include the upper end gap 310 located at an upper end of the door seating portion 200 and the lower end gap 320 located at a lower end of the door seating portion 200, and a thickness of the lower end gap 320 may be greater than a thickness of the upper end gap 310.

In an embodiment of the present disclosure, the door 100 may be disposed on the front panel 11, and thus, over time, an own weight of the door 100 may affect a location of the door 100. For example, the location of the door 100 determined in an initial design may gradually move downward over time because of the own weight of the door 100.

That is, as durability of the door 100 diminishes, the door 100 may sag because of the own weight thereof. When a degree of the sagging becomes severe, the lower end of the door 100 and the door seating portion 200 may come into contact with each other, causing noise when the door 100 pivots or preventing the door 100 from being accommodated in the door seating portion 200.

Considering the above, in an embodiment of the present disclosure, it may be determined in the gap 300 that the thickness of the lower end gap 320 is greater than that of the upper end gap 310. In this regard, deviation between the upper end gap 310 and the lower end gap 320 may be set to various degrees as needed, and the thicknesses of the upper end gap 310 and the lower end gap 320 may be set such that the upper end gap 310 and the lower end gap 320 have substantially the same thickness by compensating for an amount of sagging that occurs in the door 100 after a specific time experimentally or theoretically.

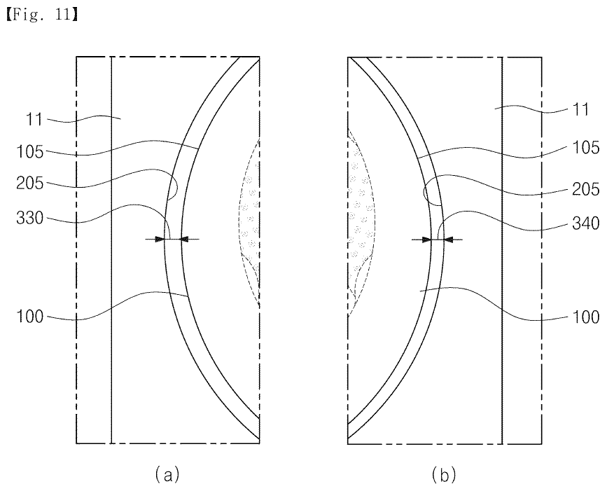

FIG. 11 shows a gap 300 located at one end of the door 100 and a gap 300 located at an opposite end of the door 100 in the gap 300 based on the width direction of the cabinet 10. (a) in FIG. 11 shows a gap 330 at one end located at one end of the door 100 in the width direction, and (b) in FIG. 11 shows a gap 340 at an opposite end located at an opposite end of the door 100 in the width direction.

In an embodiment of the present disclosure, the door 100 may be pivotably coupled to the front panel 11 via the hinge 180 at one side in the width direction of the cabinet 10, the gap 300 may include the gap 330 at the one end located at one end in the width direction of the door seating portion 200 and the gap 340 at the opposite end located at the other end in the width direction of the door seating portion 200, and a thickness of the gap 330 at the one end may be greater than a thickness of the gap 340 at the opposite end.

Specifically, the hinge 180 may be coupled to the one side of the door 100 based on the width direction. However, the hinge 180 may not be disposed to pivot around a complete end located at the one side of the door 100, and may be disposed such that a center of pivot is located at a point spaced apart from the one end by a predetermined distance.

That is, a hinge shaft, which is the center of pivot of the door 100, may be located at the point spaced by the predetermined distance apart from the one end of the door 100. Accordingly, when the door 100 pivots around the hinge shaft at the gap 330 at the one end defined at the one end of the door 100, it is necessary to secure sufficient space for the one end of the door 100 to pivot.

However, as described above, when the thickness of the entirety of the gap 300 is set to a thickness required for the gap 330 at the one end of the door 100, the gap 300 may become excessively large overall, which may lower the level of completion of the product in terms of the outer appearance and further reduce the seating stability of the door 100.

Accordingly, the thickness of the gap 330 at the one end of the door 100 may be greater than a thickness of the gap 340 at the opposite end located on an opposite side of the gap 330 at the one end of the door 100 with respect to a center of the door 100.

The gap 300 may be defined such that the thickness thereof gradually decreases as a distance from the gap 330 at the one end increases. In other words, the gap 300 may have a continuous thickness change centered on the gap 330 at the one end.

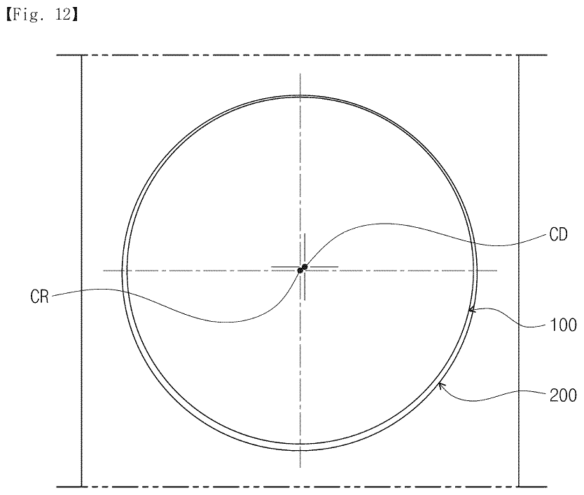

FIG. 12 shows a center CD of the door 100 and a center CR of the door seating portion 200 according to an embodiment of the present disclosure.

As described above, the gap 300 defined between the edge 205 of the door seating portion 200 and the edge 105 of the door 100 may have the different thickness depending on the location, and in other words, the center CD of the door 100 as viewed from the front may have a location different from that of the center CR of the door seating portion 200.

Specifically, in an embodiment of the present disclosure, the center CD of the door 100 as viewed from the front may be located upward of the center CR of the door seating portion 200. Accordingly, the thickness of the lower end gap 320 in the gap 300 may be greater than the thickness of the upper end gap 310, and structural interference between the lower end of the door 100 and the door seating portion 200 may be suppressed even when the door 100 sags because of the own weight thereof.

In addition, a location of the door seating portion 200 may correspond to the location of the inlet 15 of the cabinet 10 described above, and the location of the inlet 15 may correspond to the locations of the tub 30 and the accommodation portion 20 described above. In an embodiment of the present disclosure, a vertical level of the inlet 15 may be higher than that of a center of the front panel 11 for convenience of use of the user.

That is, in an embodiment of the present disclosure, a center of the inlet 15 may be positioned upward of the center of the front panel 11, and accordingly, the center CR of the door seating portion 200 may also be positioned upward of the center of the front panel 11.

Accordingly, in an embodiment of the present disclosure, the center CR of the door seating portion 200 as viewed from the front may be positioned upward of a center of the cabinet 10, and the center CD of the door 100 may be positioned upward of the center CR of the door seating portion 200.

In one example, as described above, the door 100 may be pivotably coupled to the front panel 11 via the hinge 180 at one side in the width direction of the cabinet 10.

In addition, the center CD of the door 100 as viewed from the front may be spaced apart from the center CR of the door seating portion 200 to the other side in the width direction. Accordingly, the thickness of the gap 330 at the one end of the door 100 may be greater than the thickness of the gap 340 at the opposite end of the door 100, and a space in which one end of the door 100 may pivot may be secured.

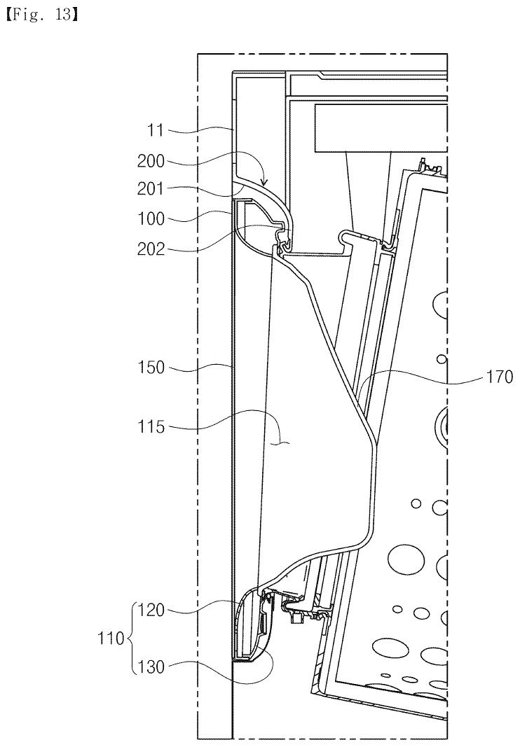

FIG. 13 shows a cross-section of the door 100 seated on the door seating portion 200 in an embodiment of the present disclosure. A structure of the door 100 will be described with reference to FIG. 13 as follows.

In an embodiment of the present disclosure, the door 100 may include the door frame 110 and the door cover 150. The door frame 110 may be pivotably coupled to the front panel 11. The door frame 110 may correspond to a body of the door 100, and the hinge 180 may be coupled with the door frame 110.

In the state DC of closing the inlet 15, the door frame 110 may be accommodated in the door seating portion 200. The door frame 110 may have the through-hole 115 defined therein.

The door cover 150 may be disposed on the front surface 122 of the door frame 110. The door cover 150 may be bonded to the front surface 122 of the door frame 110 or may be coupled thereto using other coupling members.

The door cover 150 may be disposed to cover the front surface 122 of the door frame 110, and thus the door cover 150 may be exposed forward of the cabinet 10 and may be defined as the front surface of the door 100. The door cover 150 may be disposed to cover the through-hole 115.

The door cover 150 may be made of a glass material and may have the light-transmitting property such that the through-hole 115 is visually identified from the outside of the cabinet 10. The user may visually identify the laundry accommodated inside the cabinet 10 via the door cover 150, the through-hole 115, and the inlet 15.

The door frame 110 may include an inner frame 130 and an outer frame 120. The inner frame 130 and the outer frame 120 may be coupled with each other to form the door frame 110. In the door frame 110, the inner frame 130 may be disposed to face the inside of the cabinet 10, and the outer frame 120 may be disposed to face the outside of the cabinet 10.

The outer frame 120 may be disposed on a front surface of the inner frame 130. The outer frame 120 may cover the front surface of the inner frame 130. An outer hole may be defined in the outer frame 120, an inner hole may be defined in the inner frame 130, and the outer hole and the inner hole may together define the through-hole 115.

An inner window 170 may be disposed in the door frame 110. The inner window 170 may be disposed at a rear side of the door frame 110, and may close the through-hole 115 at the rear side of the door frame 110.

The inner window 170 may be coupled to the inner frame 130, or may be coupled together at a joint portion of the outer frame 120 and the inner frame 130. The inner window 170 may cover the inner hole of the inner frame 130 and may have a shape protruding from the inner hole inward of the cabinet 10.

The through-hole 115 of the door frame 110 may be closed at a front side by the door cover 150, and may be closed at a rear side by the inner window 170. Accordingly, the through-hole 115 of the door frame 110 may be sealed from the outside.

The inner window 170, like the door cover 150, may be made of a glass material or a plastic material and have the light-transmitting property. Accordingly, the user may visually check the inside of the cabinet 10 via the door cover 150 and the inner window 170 from the space in front of the cabinet 10.

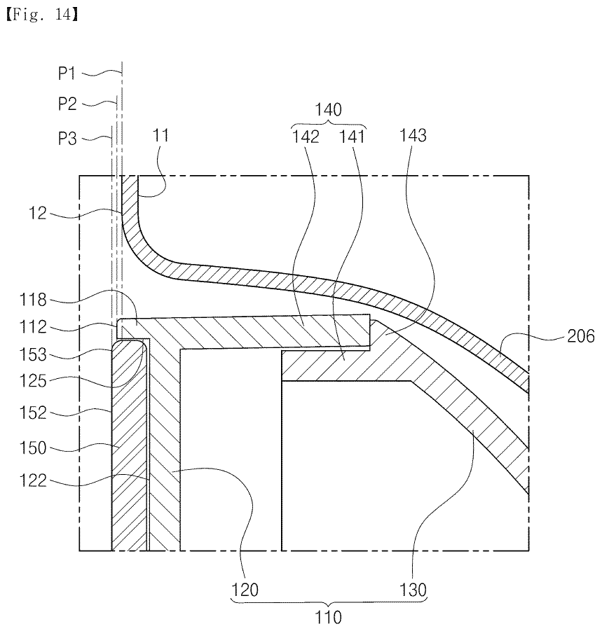

FIG. 14 shows a portion of a cross-section of the door 100 seated on the door seating portion 200. FIG. 14 shows a portion of the door frame 110 protruding forward of the front panel 11.

As described above, in an embodiment of the present disclosure, the door 100 may reduce the forward protrusion amount thereof to improve the convenience of use, the level of completion of the product in terms of the outer appearance, and space utilization.

However, when an entirety of the door 100 is accommodated inside the door seating portion 200, that is, when the entirety of the door 100 is positioned rearward of the front surface 12 of the front panel 11, it may be difficult for the entirety of the door 100 to be disposed rearward of the front surface 12 of the front panel 11.

For example, the door seating portion 200 that accommodates the entirety of the door 100 therein should have an increased depth of recession from the front panel 11, but there may be restrictions on increasing the recession depth of the door seating portion 200 because of other components such as the tub 30 or the like present inside the cabinet 10.

In addition, changes such as increasing a length in a front and rear direction of the cabinet 10 to define the door seating portion 200 for accommodation of the entirety of the door 100 may be unfavorable changes that run counter to the purpose of accommodating the entirety of the door 100.

Furthermore, simply accommodating the entirety of the door 100 in the door seating portion 200 may rather cause the door 100 to be identified as having a location to be more recessed than the front panel 11 when viewed from the front, which may lower the level of completion of the product.

Accordingly, an embodiment of the present disclosure is to improve the space utilization and the level of completion of the product by appropriately determining the location where the door 100 is accommodated while effectively reducing the forward protrusion amount of the door 100.

Referring to FIG. 14, a front end 112 of the door frame 110 may be positioned forward of the front panel 11. The door frame 110 may protrude such that a portion thereof is accommodated in the door seating portion 200 and the remainder is positioned forward of the front panel 11.

The front end 112 of the door frame 110 may be positioned forward of the front surface 12 of the front panel 11. In this regard, the front surface 12 of the front panel 11, as a surface exposed forward of the front panel 11, may refer to a surface that is approximately perpendicular to the ground. The front surface 12 of the front panel 11 may include at least a portion surrounding the door seating portion 200.

FIG. 14 shows a virtual first surface P1 on which the front surface 12 of the front panel 11 is positioned and a virtual second surface P2 on which the front end 112 of the door frame 110 is positioned. The first surface P1 and the second surface P2 may be defined perpendicular to the ground, wherein the ground may refer to a floor surface of a place where the laundry treating apparatus 1 is installed, and the second surface P2 may be positioned forward of the first surface P1.

A depth at which the door frame 110 is accommodated in the door seating portion 200 may be determined in various ways. To accommodate the door frame 110, the door seating portion 200 may have an area size greater than that of the door 100.

For example, in an embodiment of the present disclosure, the door frame 110 may include a frame circumferential portion 118 protruding forward from an edge thereof.

The frame circumferential portion 118 may protrude forward from the front surface 122 of the door frame 110 and may extend along a circumference of the door cover 150 disposed on the front surface 122 of the door frame 110. The frame circumferential portion 118 may protrude forward from the edge of the door frame 110 and extend along a circumferential surface 155 of the door cover 150. The frame circumferential portion 118 may be formed in a ring shape on the front surface 122 of the door frame 110.

The front surface 122 of the outer frame 120 described above may correspond to the front surface 122 of the door frame 110. The frame circumferential portion 118 may protrude forward from an edge of the outer frame 120 described above. However, when necessary, the frame circumferential portion 118 may also protrude forward from the inner frame 130.

In an embodiment of the present disclosure, the front end 112 of the frame circumferential portion 118 may be positioned forward of the front surface 12 of the front panel 11. A portion of the frame circumferential portion 118 may be positioned rearward of the front surface 12 of the front panel 11, and the remainder thereof may be positioned forward of the front surface 12 of the front panel 11. A portion of the frame circumferential portion 118 may be accommodated in the door seating portion 200, and the remainder thereof may protrude forward of the door seating portion 200.

That is, an embodiment of the present disclosure may improve efficiency of an arrangement relationship with other components while minimizing the protrusion amount of the door 100 by making only a portion of a front side of the door frame 110 of the door 100 protrude forward of the front surface 12 of the front panel 11 and the remainder be accommodated in the door seating portion 200.

In one example, the door 100 may include the inner frame 130 and the outer frame 120 described above, the inner frame 130 may be disposed to face the door seating portion 200, and the outer frame 120 may be positioned in front of the inner frame 130.

The door cover 150 may be disposed on the front surface 122 of the outer frame 120, and a portion of the outer frame 120 may be accommodated in the door seating portion 200 and the remainder may protrude forward of the door seating portion 200.

In other words, the portion of the outer frame 120 may be positioned rearward of the front surface 12 of the front panel 11, and the remainder may be positioned forward of the front surface 12 of the front panel 11.

The front surface 122 of the outer frame 120 may be positioned rearward of the front surface 12 of the front panel 11. As described above, an embodiment of the present disclosure may determine the efficient location of the door 100 by allowing the portion of the outer frame 120 positioned at the front side of the door frame 110 to be accommodated in the door seating portion 200 and the remainder to protrude forward of the front panel 11.

In one example, the outer frame 120 may include a cover seating portion 125 that is recessed rearward to provide a space into which at least a portion of the door cover 150 is inserted.

The cover seating portion 125 may be opened forward and include a space in which the door cover 150 is accommodated. The cover seating portion 125 may be defined by the frame circumferential portion 118 and the front surface 122 of the outer frame 120 described above.

For example, a periphery of the cover seating portion 125 may correspond to the frame circumferential portion 118, and a recessed surface of the cover seating portion 125 may be the front surface 122 of the outer frame 120. Accordingly, in an embodiment of the present disclosure, the recessed surface of the cover seating portion 125 may be positioned rearward of the front surface 12 of the front panel 11.

In an embodiment of the present disclosure, a minimum accommodated amount of the door 100 may be limited by positioning the front surface 122 of the outer frame 120 or the recessed surface of the cover seating portion 125 rearward of the front surface 12 defined in the front panel 11. In this case, a significant portion of the door 100 may be positioned within the door seating portion 200, so that the forward protrusion amount of the door 100 may be significantly reduced.

In one example, the door frame 110 may include a frame coupling portion 140 for the outer frame 120 and the inner frame 130 to be coupled to each other.

A portion of the frame coupling portion 140 may be disposed at the outer frame 120 and the remainder thereof may be disposed at the inner frame 130. The portion of the frame coupling portion 140 may be disposed at a rear surface of the outer frame 120 and the remainder of the frame coupling portion 140 may be disposed at a front surface of the inner frame 130.

The frame coupling portion 140 for the inner frame 130 and the outer frame 120 to be coupled to each other may be positioned rearward of the front surface 12 of the front panel 11. That is, the frame coupling portion 140 may not protrude forward from the front surface 12 of the front panel 11. Accordingly, an embodiment of the present disclosure may limit the forward protrusion amount of the door 100.

The frame coupling portion 140 may include a first coupling portion 141 and a second coupling portion 142.

The first coupling portion 141 may protrude from one of an edge of the inner frame 130 and an edge of the outer frame 120 toward the other. As an example, FIG. 14 shows the first coupling portion 141 protruding from the inner frame 130 toward the outer frame 120.

The second coupling portion 142 may protrude from the other toward the one, and may be disposed outward of the first coupling portion 141 along the radial direction of the inlet 15 to be coupled with the first coupling portion 141. In FIG. 14, as an example, the second coupling portion 142 protruding from the outer frame 120 toward the inner frame 130 is shown.

Each of the first coupling portion 141 and the second coupling portion 142 may have a ring shape forming a closed cross-section, and when necessary, at least one of the first coupling portion 141 and the second coupling portion 142 may have a shape of a rib spaced apart along a periphery of the door frame 110.

In one example, the frame coupling portion 140 may further include a support 143. The support 143 may protrude along the radial direction of the inlet 15 from one of the edge of the inner frame 130 and the edge of the outer frame 120 to support the end of the second coupling portion 142 forwardly or rearwardly.

FIG. 14 shows, as an example, the ring-shaped support 143 that protrudes outward in the radial direction of the door 100 from the edge of the inner frame 130 and extends along the edge of the inner frame 130. The support 143 may support a rear end of the second coupling portion 142 forwardly.

In one example, a front surface 152 of the door cover 150 may define the front surface of the door 100. In an embodiment of the present disclosure, an edge 153 of the front surface 152 of the door cover 150 may be positioned forward of the front end 112 of the frame circumferential portion 118. In an embodiment of the present disclosure, at least a portion of the door cover 150 may be positioned forward of the front surface 12 of the front panel 11.

FIG. 14 shows a virtual third surface P3 where the edge 153 of the front surface 152 of the door cover 150 is positioned. The third surface P3 may be defined perpendicular to the ground and positioned forward of the second surface P2.

Accordingly, providing a design effect that the door cover 150 of the door 100 is recessed rearward in the front panel 11 may be suppressed and a planarization effect of the front panel 11 may be provided.

However, a front end of the door cover 150 may not necessarily be positioned forward of the front end 112 of the door frame 110. Specifically, in an embodiment of the present disclosure, the edge 153 of the front surface 152 of the door cover 150 and the front end 112 of the frame circumferential portion 118 may be positioned together on one surface perpendicular to the ground.

In one example, the door cover 150 may protrude forward from the front panel 11. Referring to FIG. 14, the third surface P3 defined by the door cover 150 may be positioned forward of the first surface P1 defined by the front panel 11.

Accordingly, an effect similar to that of the door cover 150 being positioned on the same plane as the front surface 12 of the front panel 11 may be proposed. Specifically, the interior of the cabinet 10, for example, the interior of the accommodation portion 20, may be visually exposed to the outside via the inlet 15 of the cabinet 10 and the through-hole 115 of the door 100.

However, the interior of the cabinet 10 does not have a luminous body and is a space shielded from the outside, so that the interior of the cabinet 10 may have a low brightness and the door 100, which has the through-hole 115, may also have a relatively low brightness.

Furthermore, to eliminate a visual difference between the through-hole 115 and the remaining portion, the door cover 150 may have a brightness corresponding to that of the through-hole 115 at least in the portion other than the through-hole 115.

Accordingly, in an embodiment of the present disclosure, the door cover 150 may have a color with a brightness lower than that of the front panel 11. As such, the door 100 may have the low brightness in a relationship with the front panel 11 or in a general view, and accordingly, the door 100 may produce a visual effect of being recessed in the front panel 11 inward of the cabinet 10 by a certain amount.

In an embodiment of the present disclosure, to provide the visual effect to the user that the door 100 equipped with the door cover 150 and the front surface 12 of the front panel 11 are present together on a single plane, the edge 153 of the front surface 152 of the door cover 150 or the front end 112 of the door frame 110, which may correspond to a front end of the door 100, may be disposed to protrude by a certain amount forward of the front surface 12 of the front panel 11.

For example, in an embodiment of the present disclosure, the edge 153 of the front surface 152 of the door cover 150 may be positioned forward of the front surface 12 of the front panel 11. The door cover 150 may be formed such that a center thereof protrudes further than the edge 153 of the front surface 152. However, in an embodiment of the present disclosure, at least the edge 153 of the front surface 152 of the door cover 150 may be positioned forward of the front surface 12 of the front panel 11.

Furthermore, in an embodiment of the present disclosure, the front surface 152 of the door cover 150 may be a plane perpendicular to the ground and may be positioned forward of the front surface 12 of the front panel 11. That is, the front surface 152 of the door cover 150 may be positioned together with the edge 153 of the front surface 152 of the door cover 150 described above on the same plane perpendicular to the ground, for example, the third surface P3, and the third surface P3 may be positioned forward of the first surface P1 corresponding to the front surface 12 of the front panel 11.

In one example, in addition to the visual effect of the door 100 described above, an embodiment of the present disclosure is to limit the forward protrusion amount of the door 100. Accordingly, in an embodiment of the present disclosure, the portion of the door cover 150 may be positioned rearward of the front surface 12 of the front panel 11, and the edge 153 of the front surface 152 of the door cover 150 may be positioned forward of the front surface 12 of the front panel 11.

In one example, as described above, the door cover 150 may protrude forward of the front end 112 of the door frame 110. The second surface P2 defined by the front surface 122 of the door frame 110 may be positioned rearward of the third surface P3 defined by the edge 153 of the front surface 152 of the door cover 150.

Accordingly, the visual effect that the door cover 150, which is designed to have the low brightness on its own, is positioned forward of the actual front panel 11 to form the same plane as the front surface 12 of the front panel 11 may be improved.

However, as described above, the door cover 150 does not necessarily protrude forward of the door frame 110. In an embodiment of the present disclosure, the edge 153 of the front surface 152 of the door cover 150 may be positioned together with the front end 112 of the door frame 110 on the virtual plane perpendicular to the ground, or may be positioned forward of the front end 112 of the door frame 110.

In one example, the above-mentioned frame circumferential portion 118 may protrude forward from the edge of the outer frame 120, and in the door frame 110, the portion of the frame circumferential portion 118 may be accommodated in the door seating portion 200 and the remainder thereof may protrude forward of the door seating portion 200.

The door cover 150 may protrude forward of the frame circumferential portion 118, the cover seating portion 125 recessed rearward may be defined in the front surface 122 of the door frame 110, and the portion of the door cover 150 may be accommodated in the cover seating portion 125 and the remainder thereof may protrude forward of the door frame 110.

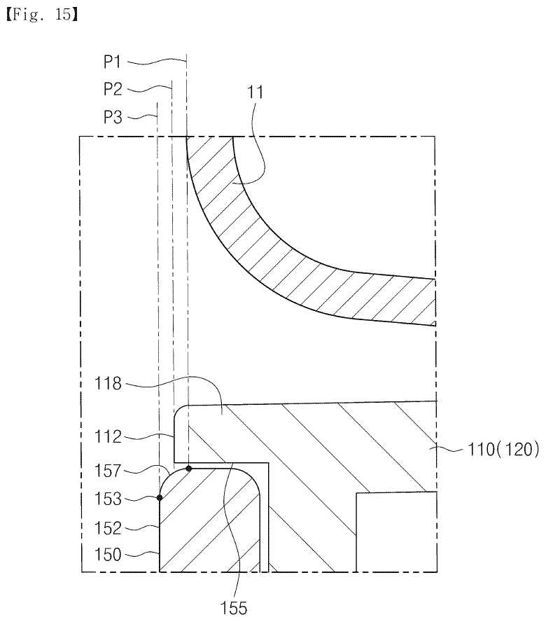

FIG. 15 shows the door cover 150 that protrudes forward of the front end 112 of the door frame 110.

Referring to FIG. 15, the door cover 150 may include a connecting curved surface 157 connecting the edge 153 of the front surface 152 of the door cover 150 with a front end of the circumferential surface 155 of the door cover 150.

Specifically, the front surface 152 of the door cover 150 may face forward and be exposed to the outside. The front surface 152 of the door cover 150 may be approximately circular. The front surface 152 of the door cover 150 may correspond to the front surface of the door 100.

The circumferential surface 155 of the door cover 150 may have a ring shape extending along an edge of the door cover 150, and may face a frame protrusion and come into contact with the frame protrusion. The connecting curved surface 157 may connect the front surface 152 and the circumferential surface 155 of the door cover 150 to each other, and at least a portion thereof may be exposed forwardly of the door 100.

The connecting curved surface 157 may be a curved surface positioned between the front surface 152 of the door cover 150 and the circumferential surface 155 of the door cover 150. One end of the connecting curved surface 157 may be connected to the edge 153 of the front surface 152, and the other end thereof may be connected to the front end of the circumferential surface 155.

The connecting curved surface 157 may correspond to a front corner of the door cover 150, and the front corner exposed to the user may be formed to be rounded by the connecting curved surface 157, so that safety of use may be improved and ease of handling of the door cover 150 may be improved.

In an embodiment of the present disclosure, at least a portion of the connecting curved surface 157 may protrude forward of the front panel 11. That is, at least the portion of the connecting curved surface 157 may protrude forward of the front end 112 of the door frame 110.

A front end of the connecting curved surface 157 may be positioned forward of the front end 112 of the door frame 110, and a rear end of the connecting curved surface 157 may be positioned rearward of the front end 112 of the door frame 110. Accordingly, the second surface P2 may be positioned to cross the connecting curved surface 157.

The front end of the connecting curved surface 157, that is, the edge 153 of the front surface 152 of the door cover 150, may be positioned forward of the front end 112 of the door frame 110, and the rear end of the connecting curved surface 157, that is, the front end of the circumferential surface 155 of the door cover 150, may be positioned rearward of the front end 112 of the door frame 110.

That is, at least a portion of the circumferential surface 155 of the door cover 150 may be positioned rearward of the front surface 12 of the front panel 11. The circumferential surface 155 of the door cover 150 may be positioned rearward of the front end 112 of the door frame 110.

An entirety of the circumferential surface 155 of the door cover 150 may be accommodated within the cover seating portion 125 of the door frame 110. The front end of the circumferential surface 155 of the door cover 150 may be positioned on the first surface P1 described above.

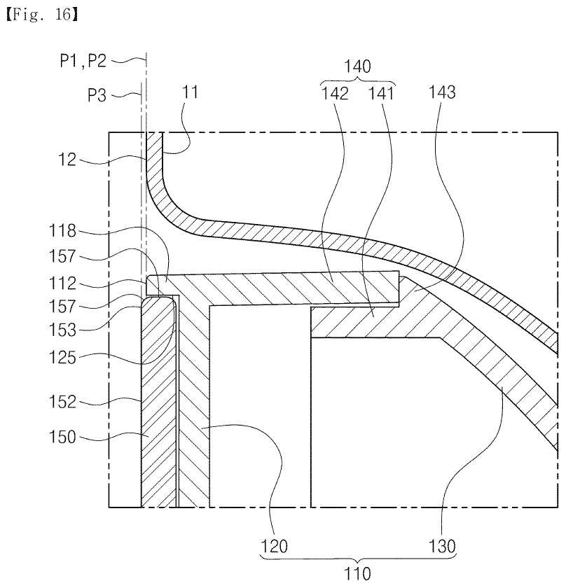

FIG. 16 shows the door 100 in a state in which the door frame 110 does not protrude forward of the front panel 11 in an embodiment of the present disclosure. Hereinafter, with reference to FIG. 16, a structure in which an entirety of the door frame 110 is accommodated in the door seating portion 200 will be described.

Specifically, in an embodiment of the present disclosure, the door 100 may partially protrude forward of the front panel 11 in terms of space utilization with other components as described above, but the entirety of the door frame 110 may also be accommodated in the door seating portion 200 as in a case in which a size or the like of the door 100 is reduced.

That is, in an embodiment of the present disclosure, the door frame 110 may be accommodated in the door seating portion 200 so as not to protrude forward of the front panel 11. As described above, in a situation in which problems such as ease of space utilization with the internal components of the cabinet 10 may be overcome, for example, when the size of the door 100 is reduced or an overall size of the cabinet 10 is increased for other reasons, the entirety of the door frame 110 may be accommodated in the door seating portion 200 as described above, which may be advantageous in that the forward protrusion amount of the door 100 may be minimized.

In an embodiment of the present disclosure, the outer frame 120 of the door frame 110 may be accommodated in the door seating portion 200 so as not to protrude forward of the front panel 11. Furthermore, the frame circumferential portion 118 may be disposed at the outer frame 120 and may correspond to the front end 112 of the door frame 110.

As described above, the door 100 may be seated in the door seating portion 200 such that the front end 112 of the frame circumferential portion 118 corresponding to the front end 112 of the door frame 110 is positioned within the door seating portion 200. That is, the door 100 may be accommodated in the door seating portion 200 such that the front end 112 of the frame circumferential portion 118 does not protrude forward of the front panel 11.

In one example, in an embodiment of the present disclosure, in terms of the implementation of the flattened image of the front surface and the utilization of the internal space of the cabinet 10 described above, even when the entirety of the door frame 110 is accommodated in the door seating portion 200, it is necessary to limit a location of the front end 112 of the door frame 110.

For example, in an embodiment of the present disclosure, the front end 112 of the door frame 110 may be positioned on the same plane as the front surface 12 of the front panel 11. That is, the second surface P2 by the front end 112 of the door frame 110 may be the same surface as the first surface P1 by the front surface 12 of the front panel 11.

In other words, the front end 112 of the frame circumferential portion 118 may be positioned on the same plane as the front surface 12 of the front panel 11. Accordingly, an embodiment of the present disclosure may minimize the protrusion amount of the door 100 with respect to the front panel 11, and further achieve the flattened image of the front surface of the cabinet 10 and secure an internal space of the cabinet 10.

In one example, the edge 153 of the front surface 152 of the door cover 150 may be positioned forward of the front surface 12 of the front panel 11. The front surface 152 of the door cover 150 may be a plane perpendicular to the ground and may be positioned forward of the front surface 12 of the front panel 11.

However, the door cover 150 need not be entirely positioned forward of the front surface 12 of the front panel 11, and a portion of the door cover 150 may be accommodated in the door seating portion 200 and positioned rearward of the front surface 12 of the front panel 11.

The edge 153 of the front surface 152 of the door cover 150 may be positioned rearward of the front end 112 of the door frame 110. The edge 153 of the front surface 152 of the door cover 150 may be positioned forward of the front surface 12 of the front panel 11. The edge 153 of the front surface 152 of the door cover 150 may protrude forward of the frame circumferential portion 118.

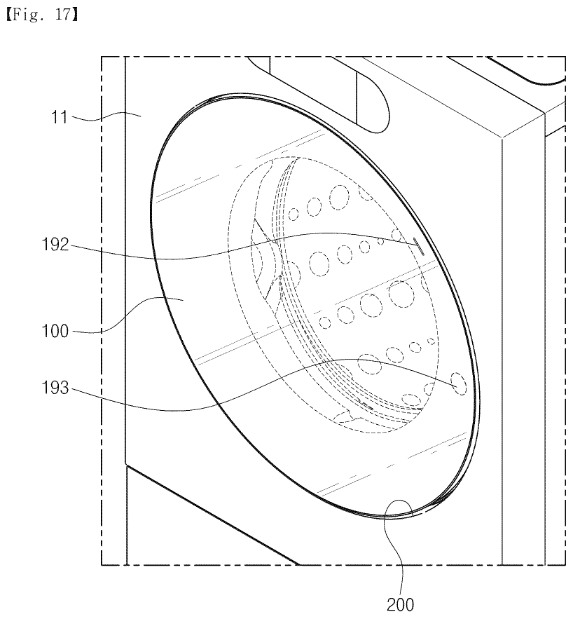

FIG. 17 shows a door button 192 and a pressing portion 193 disposed on the door 100 according to an embodiment of the present disclosure.

Specifically, when the protrusion amount of the door 100 from the door seating portion 200 is reduced as described above, the door 100 may not have a portion to be equipped with a handle, and thus the handle may be omitted.

In an embodiment of the present disclosure, the door 100, which provides the image of being positioned approximately on the same plane as the front surface 12 of the front panel 11, needs to secure a separate means therefor because it is difficult for the handle or other similar components to be gripped by the user to exist.

In an embodiment of the present disclosure, the door 100 may include the door button 192 and the pressing portion 193. The door 100 may be maintained in the closing state DC via the door lock 190 described above, and the door lock 190 may be disposed on the cabinet 10 and may restrain forward pivoting of the door 100 in the closing state DC accommodated in the door seating portion 200.

In one example, when the door button 192 or the pressing portion 193 is manipulated, the door lock 190 may unlock the door 100 and push the door 100 forward by a certain amount.

In the closing state DC, the door 100, which has no portion that the user may grip, may induce the pivoting of the door 100 to induce the opening of the door 100 and enable the gripping of the user while minimizing the forward protrusion amount of the door 100 as the door button 192 or the pressing portion 193 is manipulated.

The door button 192 may be exposed on the front surface of the door 100. The door button 192 may be manipulated by the user to input an unlock command for the door lock 190.

The door button 192 may be of various types. The door button 192 may be a mechanical button physically manipulated to change a protrusion amount thereof or a touch button equipped with a touch film or the like to sense a user's touch.

The door button 192 may be positioned upward of a horizontal center line of the door 100 for convenience of use. The door button 192 may be positioned between an upper end of a periphery of the door 100 and the horizontal center line of the door 100.

When the door button 192 disposed on the front surface of the door 100 is manipulated, the door lock 190 may release the restraint of the door 100 and push the door 100 forward.

When the door button 192 is manipulated by the user, the unlocking command by the user may be transmitted to the door lock 190 via a controller. The door lock 190 may push the door 100 forward via an elastic body or the like. A detailed description of the door lock 190 will be made later.

In one example, in an embodiment of the present disclosure, the door 100 may include the pressing portion 193 in addition to the door button 192. The pressing portion 193, as an area for physically pressing the door lock 190, may be positioned overlapping or adjacent to the door lock 190.

When the door 100 whose forward pivoting is restrained is pressed toward the cabinet 10, the door lock 190 may release the restraint of the door 100 and push the door 100 forward.

In an embodiment of the present disclosure, the door lock 190 may automatically unlock via the manipulation of the door button 192, and furthermore, may mechanically unlock by being pressed rearward by the door 100.

Specifically, the door button 192 described above may be a means for commanding the door lock 190 to unlock via an electrical signal. When the unlocking command generated via the door button 192 is transmitted to the door lock 190, the door lock 190 may unlock itself and push the door 100.

However, when the laundry treating apparatus 1 according to an embodiment of the present disclosure is not supplied with power or a failure occurs in a power system component, the command using the door button 192 is not able to be transmitted to the door lock 190 and the door lock 190 is also not able to unlock itself, so that there may be difficulty in pivoting the door 100 to be in the opening state DO.

In this case, the user may open the door 100 by physically unlocking the door lock 190 via the pressing portion 193.

A scheme the door lock 190 is opened by a pressing force may vary. For example, the door lock 190 may include a catch 196 that catches the locking protrusion 195 of the door 100 described above and restricts a forward movement thereof. When the pressing force is applied toward the cabinet 10 in the locking state of fixing the door 100, the catch 196 may move, releasing the forward movement restriction of the locking protrusion 195, thereby allowing the door 100 to be unlocked.

The pressing portion 193 may be defined in the door cover 150. The pressing portion 193 may be located in front of the door lock 190 or adjacent to a front area of the door lock 190. The pressing portion 193 may be constructed as a means for directly generating the pressing force when being pressed by the user or for simply guiding a location where to be pressed by the user.

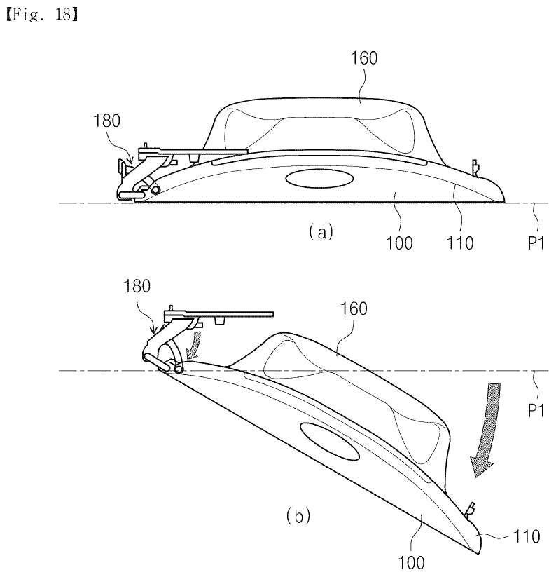

FIG. 18 shows the door 100 that is switched between the closing state DC and the opening state DO by the door lock 190 according to an embodiment of the present disclosure. (a) in FIG. 18 shows the door 100 that is seated on the door seating portion 200 based on the locking state of the door lock 190, and (b) in FIG. 18 shows the door 100 that is pivoted forward from the door seating portion 200 based on the unlocking state of the door lock 190.

As shown in (a) in FIG. 18, in an embodiment of the present disclosure, the door 100 may be accommodated in the door seating portion 200 in the closing state DC of closing the inlet 15 of the cabinet 10 as described above, so that the front surface of the door 100 may become approximately parallel to the front surface 12 of the front panel 11. In addition, in the closing state DC of the door 100, the door lock 190 may restrain the pivoting of the door 100 and prevent the forward pivoting of the door 100.

As shown in (b) in FIG. 18, when the door lock 190 is switched from the locking state to the unlocking state, the door lock 190 may push the door 100 forward, and accordingly, the door 100 may be pivoted about the hinge 180 such that at least a portion thereof protrudes forward from the door seating portion 200.

In this regard, the user may directly pivot the door 100 that has been pivoted forward as much as desired to expose the inlet 15 of the cabinet 10 and put the laundry into the inlet 15.

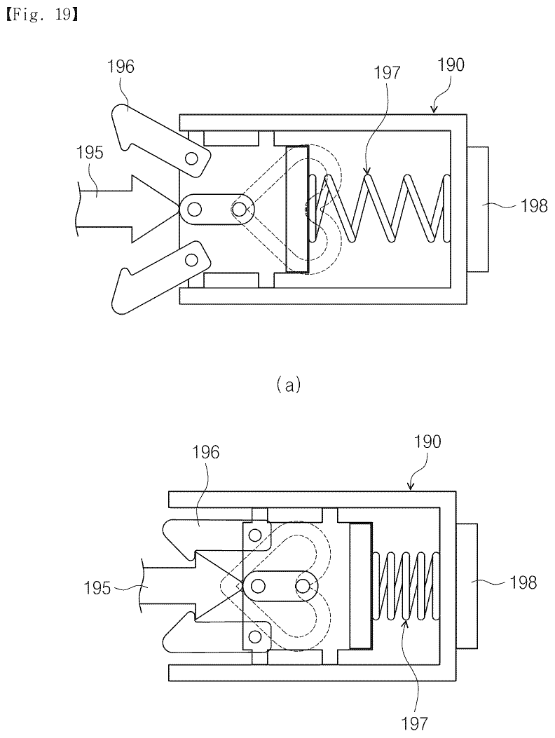

FIG. 19 shows an operation process of the door lock 190 according to an embodiment of the present disclosure. (a) in FIG. 19 shows the door lock 190 of the door 100 in the unlocking state, and (b) in FIG. 19 shows the door lock 190 of the door 100 in the locking state.

Referring to FIG. 19, the door 100 may include the locking protrusion 195 protruding toward the door lock 190. The locking protrusion 195 may protrude rearward from the inner frame 130 of the door 100.

The door lock 190 may include a housing into which the locking protrusion 195 is inserted, and may include the catch 196 that catches the locking protrusion 195 that is inserted into the housing and restricts the forward movement of the locking protrusion 195.

In the opening state DO of the door 100, when the locking protrusion 195 located in front of the door lock 190 is inserted into the door lock 190 by the pivoting of the door 100 for the state DC of closing the inlet 15, the pressing force by the locking protrusion 195 may be applied to the door lock 190.

In the door lock 190, the catch 196 may be moved to a locking location by the pressing force of the locking protrusion 195, and at least a portion of the catch 196 located in the locking location may be located in front of the locking protrusion 195 to restrict the forward movement of the locking protrusion 195.

In this regard, the door lock 190 may include a fixer for fixing the location of the catch 196 in the locking state, and an elastic member 197 disposed in the door lock 190 may maintain a compressed state by the pressing force of the locking protrusion 195.

In one example, when the door button 192 described above is manipulated, the unlocking command by the door button 192 may be received by an automatic unlocking means 198 disposed in the door lock 190. When the unlocking command is received by the automatic unlocking means 198, the fixer may be released, so that the catch 196 may move from the locking location to the unlocking location, and accordingly, the caught state of the locking protrusion 195 may be released.

When the forward movement of the locking protrusion 195 becomes free, the elastic member 197 described above may be restored from the compressed state to the original state, and at this time, a restoring force of the elastic member 197 may act on the locking protrusion 195 to push the locking protrusion 195 forward. As the locking protrusion 195 moves forward, the door 100 described above may move forward.

In one example, when the pressing portion 193 described above is pressed in the locking state of the door lock 190, that is, when a rearward pressing force is applied to the door lock 190 by the door 100, the above-described fixer of the door lock 190 may be switched from the locking state to the unlocking state via a mechanical mechanism.

Accordingly, by pressing the pressing portion 193, the door lock 190 may be switched from the locking state to the unlocking state in a manner similar to that in the situation in which the above-described door button 192 is manipulated, and push the locking protrusion 195 forward via the elastic member 197.

However, the operation process of the door lock 190 may not be necessarily limited to the above, and the locking protrusion 195 of the door 100 may be fixed or released in various ways as needed.

Furthermore, although the description has been made that the situation in which the door button 192 is manipulated and the situation in which the pressing portion 193 is pressurized are generally similar operation processes of the door lock 190, the fixed state of the locking protrusion 195 may be released via different mechanisms as needed.

While the present disclosure has been illustrated and described with respect to the specific embodiment, it will be apparent to those skilled in the art that the present disclosure may be variously improved and modified without departing from the technical spirit of the present disclosure as defined by the following claims.

What is claimed is:

1. A laundry treating apparatus comprising:
a cabinet including a front panel having an inlet defined therein;
an accommodation portion disposed inside the cabinet to accommodate laundry input via the inlet therein;
a door seating portion defined in the front panel, surrounding the inlet, and recessed rearward; and
a door pivotably disposed on the front panel to open and close the inlet, wherein at least a portion of the door is accommodated in the door seating portion in a state of closing the inlet,
wherein the door includes:
a door frame pivotably coupled to the front panel and accommodated in the door seating portion; and
a door cover covering a front surface of the door frame and exposed forward,
wherein the door frame is configured to be accommodated in the door seating portion so as not to protrude forward of the front panel.

2. The laundry treating apparatus of claim 1, wherein a front end of the door frame is configured to be positioned on the same plane as a front surface of the front panel.

3. The laundry treating apparatus of claim 1, wherein an edge of the door frame includes a frame circumferential portion protruding forward and extending along an edge of the door cover, wherein the door is configured to be accommodated in the door seating portion such that a front end of the frame circumferential portion does not protrude forward of the front panel.

4. The laundry treating apparatus of claim 3, wherein the front end of the frame circumferential portion is positioned on the same plane as a front surface of the front panel.

5. The laundry treating apparatus of claim 1, wherein the door frame includes:
an outer frame having the door cover disposed on a front surface thereof; and
an inner frame coupled to the outer frame from the rear and facing the inlet,
wherein the outer frame is configured to be accommodated in the door seating portion so as not to protrude forward of the front panel.

6. The laundry treating apparatus of claim 5, wherein a frame circumferential portion protruding forward and extending along an edge of the door cover is configured to be disposed at an edge of the outer frame,
wherein the frame circumferential portion is configured to be accommodated in the door seating portion so as not to protrude forward of the front panel.

7. The laundry treating apparatus of claim 1, wherein an edge of a front surface of the door cover is configured to be positioned forward of a front surface of the front panel.

8. The laundry treating apparatus of claim 7, wherein a portion of the door cover is configured to be accommodated in the door seating portion and positioned rearward of the front surface of the front panel.

9. The laundry treating apparatus of claim 1, wherein a cover seating portion recessed rearward is defined in the front surface of the door frame,
wherein a portion of the door cover is configured to be accommodated in the cover seating portion and a remainder thereof protrudes forward of the door frame.

10. The laundry treating apparatus of claim 1, wherein an edge of the door frame includes a frame circumferential portion protruding forward and extending along a circumferential surface of the door cover,
wherein an edge of a front surface of the door cover is configured to protrude forward of the frame circumferential portion.

11. The laundry treating apparatus of claim 1, wherein the door cover includes a connecting curved surface connecting an edge of a front surface of the door cover with a front end of a circumferential surface of the door cover,
wherein at least a portion of the connecting curved surface is configured to protrude forward of the front panel.

12. The laundry treating apparatus of claim 11, wherein at least a portion of the circumferential surface of the door cover is configured to be positioned rearward of a front surface of the front panel.

13. The laundry treating apparatus of claim 1, wherein the front surface of the door frame is configured to be positioned rearward of a front surface of the front panel,
wherein an edge of a front surface of the door cover is configured to be positioned forward of the front surface of the front panel.
